(19) United States
(12) Patent Application Publication
(10) Pub. No.: US 2014/0269185 A1
(43) Pub. Date: Sep. 18, 2014

(54) TIME-LAPSE MONITORING

(71) Applicant: WESTERNGECO L.L.C., Houston, TX (US)

(72) Inventors: RALF G. FERBER, HORSHAM (GB); ALI ÖZBEK, MILTON (GB); MASSIMILIANO VASSALLO, BRIGHTON (GB); DAVID NIGEL TODHUNTER, KEMPSTON (GB)

(73) Assignee: WESTERNGECO L.L.C., Houston, TX (US)

(21) Appl. No.: 14/205,133

(22) Filed: Mar. 11, 2014

Related U.S. Application Data
(60) Provisional application No. 61/777,954, filed on Mar. 12, 2013.

(51) Int. Cl. G01V 1/30

(52) U.S. Cl. CPC G01V 1/308
USPC 367/38

(57) ABSTRACT

Described herein are implementations of various technologies for a method. The method may receive a baseline survey dataset for a region of interest. The method may obtain a transformed dataset from the baseline survey dataset using a transform. The method may determine sparsity characteristics from the transformed dataset. The method may determine survey parameters using the sparsity characteristics. The survey parameters may be for a monitor survey for the region of interest.

### CROSS-REFERENCE TO RELATED APPLICATION

This application claims the benefit of κ. S. Provisional Patent Application Ser. No. 61/777,954 filed Mar. 12, 2013, which is incorporated herein by reference in its entirety.

### BACKGROUND

This section is intended to provide background information to facilitate a better understanding of various technologies disclosed herein. As the section's title implies, this is a discussion of related art. That such art is related in no way implies that it is prior art. The related art may or may not be prior art. It should therefore be understood that the statements in this section are to be read in this light, and applicant neither concedes nor acquiesces to the position that any given reference is prior art or analogous prior art.

In a typical seismic survey, a plurality of seismic sources, such as explosives, vibrators, airguns or the like, may be sequentially activated at or near the surface of the earth to generate energy which may propagate into and through the earth. The seismic waves may be reflected back by geological formations within the earth. The resultant seismic wavefield may be sampled by a plurality of seismic sensors, such as geophones, hydrophones and the like. Each sensor may be configured to acquire seismic data, normally in the form of a record or trace representing the value of some characteristic of the seismic wavefield against time. The acquired seismic data may be transmitted over electrical or optical cables to a recorder system. The recorder system may then store, analyze, and/or transmit the data. This data may be used to detect the possible presence of hydrocarbons, changes in the subsurface, and the like.

In a typical time-lapse seismic survey, a second or monitor survey may be performed in the same location as a previous baseline survey for the purpose of comparing the images produced by the two surveys. In one operation example, the sources may be activated at the same locations and the sensors may be located at the same locations in both surveys. The images may be subtracted to create the time-lapse difference image. A time-lapse difference image represents any change to the subsurface layers since the baseline survey was performed. For example, the difference image may reveal the places in which the oil-and-water contact has moved indicating the areas from which oil has been pumped. If the oil-and-water contact is not changing in expected areas of the reservoir, another well may be installed to tap into that area.

To maximize the usefulness of seismic surveys performed and minimize overall site cost, it may be desirable that seismic surveys performed after an initial survey yield new seismic data to capture further aspects of the area's subsurface. In addition, typical time-lapse surveys strive to repeat a baseline survey's source and sensor placement as closely as possible in order to compute a difference image.

As those with skill in the art will appreciate, processing techniques for seismic data may be successfully applied to other types of collected data in varying circumstances as will be discussed herein.

Accordingly, there is a need for methods and computing systems that can employ more effective and accurate methods for identifying, isolating, and/or processing various aspects of seismic signals or other data that is collected from a subsurface region or other multi-dimensional space, including time-lapse seismic reservoir monitoring.

### SUMMARY

In accordance with some implementations, a method for processing collected data is provided. The method may receive a baseline survey dataset for a region of interest. The method may obtain a transformed dataset from the baseline survey dataset using a transform. The method may determine sparsity characteristics from the transformed dataset. The method may determine survey parameters using the sparsity characteristics. The survey parameters may be for a monitor survey for the region of interest.

In accordance with some implementations, a method for processing collected data is provided. The method may receive a legacy survey dataset for a region of interest. The method may obtain a transformed dataset from the legacy survey dataset using a transform. The method may determine sparsity characteristics from the transformed dataset. The method may determine survey parameters using the sparsity characteristics. The survey parameters may be for a seismic survey for the region of interest.

In accordance with some implementations, a method for processing collected data is provided. The method may receive data collected from a first imaging procedure performed on a multi-dimensional region of interest. The method may obtain a transformed data from the received data using a transform. The method may determine sparsity characteristics from the transformed data. The method may determine imaging parameters using the sparsity characteristics. The imaging parameters may describe a second imaging procedure.

The above referenced summary section is provided to introduce a selection of concepts that are further described below in the detailed description section. The summary is not intended to identify features of the claimed subject matter, nor is it intended to be used to limit the scope of the claimed subject matter. Furthermore, the claimed subject matter is not limited to implementations that solve any or most disadvantages noted in any part of this disclosure. Indeed, the systems, methods, processing procedures, techniques, and workflows disclosed herein may complement or replace conventional methods for identifying, isolating, and/or processing various aspects of seismic signals or other data that is collected from a subsurface region or other multi-dimensional space, including time-lapse seismic data collected in a plurality of surveys.

### BRIEF DESCRIPTION OF THE DRAWINGS

Implementations of various technologies will hereafter be described with reference to the accompanying drawings. It should be understood, however, that the accompanying drawings illustrate some embodiments disclosed herein and are not meant to limit the scope of various technologies disclosed herein.

FIG. 1 illustrates a seismic acquisition system in connection with some implementations of various technologies disclosed herein.

FIG. 2 illustrates a flow diagram of a method for designing and performing a monitor survey in accordance with some embodiments disclosed herein.

FIG. 3 illustrates a schematic diagram of a computing system in which the various technologies disclosed herein may be incorporated and practiced.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

Reference will now be made in detail to various implementations, examples of which are illustrated in the accompanying drawings and figures. In the following detailed description, numerous specific details are set forth in order to provide a thorough understanding of the claimed invention. However, it will be apparent to one of ordinary skill in the art that the claimed invention may be practiced without these specific details. In other instances, well known methods, procedures, components, circuits, and networks have not been described in detail so as not to unnecessarily obscure aspects of the claimed invention.

It will also be understood that, although the terms first, second, etc. may be used herein to describe various elements, these elements should not be limited by these terms. These terms are used to distinguish one element from another. For example, a first object or block could be termed a second object or block, and, similarly, a second object or block could be termed a first object or block, without departing from the scope of the invention. The first object or block, and the second object or block, are both objects or blocks, respectively, but they are not to be considered the same object or block.

The terminology used in the description herein is for the purpose of describing particular implementations and is not intended to limit the claimed invention. As used herein, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises,” and/or “comprising,” when used in this specification, specify the presence of stated features, integers, blocks, operations, elements, and/or components, but do not preclude the presence or addition of one or more other features, integers, blocks, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

FIG. 1 illustrates a seismic acquisition system 100 in accordance with implementations of various technologies disclosed herein. In one implementation, the seismic acquisition system 100 may include one or more seismic sources 110, a plurality of seismic sensors 130, one or more data collection units 140 and a fixed-base facility 160. In operation, a source 110 may generate a plurality of seismic signals 115 into the earth. The seismic signals 115 may be reflected by subterranean geological formations 120 and return to the sensors 130. The sensors 130 may then acquire and record the seismic signals 125. The sensors 130 may then transmit the recorded seismic data via wired or wireless links to a data collection unit 140. The data collection unit 140, which may include one or more single recorder systems, may be configured to store, process and/or transmit the seismic data. The data from the data collection unit 140 may be transmitted to the fixed-base facility 160 via a satellite 150 and satellite links 145.

After raw seismic data have been acquired by the seismic acquisition system 100, the reflected traces received by each of the sensors as a result of the actuation of a source of seismic energy may be processed to produce an image of the earth's interior. During processing of the seismic data obtained in a typical seismic survey, the traces may be initially sorted so that traces having the same Common Mid-point (CMP) are grouped together. A group of traces sharing a CMP is known as a CMP gather. This may enable the geology beneath the line of sources and sensors to be probed at a number of positions. The number of traces recorded for a CMP may be referred to as the fold of the data. Higher fold may enhance the quality of seismic data when the data are stacked.

One example of a time-lapse survey is a monitor survey. The monitor survey may enhance the fold of the baseline survey as well as provide a difference signal. In order to derive a time lapse difference image, monitor traces may be subtracted from baseline traces. The monitor survey may measure changes to the subsurface for a region of interest.

Compressive sampling or compressive sensing is an emerging theory that states that it may be possible if certain circumstances are met to reconstruct images or signals accurately with a number of samples far smaller than the requirements of Nyquist sampling. This smaller dataset is referred to as “sparse data” or “compressible” data. To recover unrecorded data from sparse data, data processing algorithms may seek the sparsest signal in some discrete signal space basis that agrees with recorded measurements.

The following paragraphs provide a brief overview of compressive sampling theory, which is described in more detail in Emmanuel J. Candès, “Compressive Sampling” from the Proceedings of the International Congress of Mathematicians, Madrid, Spain 2006, European Mathematical Society (“Candès”).
Consider the general problem of reconstructing a vector x εRN from linear measurements y about x of the form

yₖ= [symbol] x,φk [symbol] ,k=1, . . . ,K,or y=Φx. (2.1)
That is, we acquire information about the unknown signal by sensing x against K vectors φₖ εR^{N}. We are interested in the “underdetermined” case K<<N, where we have many fewer measurements than unknown signal values. Problems of this type arise in a countless number of applications. In radiology and biomedical imaging for instance, one is typically able to collect far fewer measurements about an image of interest than the number of unknown pixels. In wideband radio frequency signal analysis, one may only be able to acquire a signal at a rate which is far lower than the Nyquist rate because of current limitations in Analog-to-Digital Converter technology.
At first glance, solving the underdertermined system of equations appears hopeless, as it is easy to make up examples for which it clearly cannot be done. But suppose now that the signal x is compressible, meaning that it essentially depends on a number of degrees of freedom which is smaller than N. For instance, suppose our signal is sparse in the sense that it can be written either exactly or accurately as a superposition of a small number of vectors in some fixed basis. Then this premise radically changes the problem, making the search for solutions feasible. In fact, accurate and sometimes exact recovery is possible by solving a simple convex optimization problem.
It might be best to consider a concrete example first. Suppose here that one collects an incomplete set of frequency samples of a discrete signal x of length N. (To ease the exposition, we consider a model problem in one dimension. The theory extends easily to higher dimensions. For instance, we could be equally interested in the reconstruction of 2- or 3-dimensional objects from undersampled Fourier data.) The goal is to reconstruct the full signal f given only K samples in the Fourier domain

$${y}_{k} = \frac{1}{\sqrt{N}} {\sum }_{i = 0}^{N - 1} {x}_{t} {e}^{- i 2 π {ω}_{k} t / N} . \qquad ( 2.2 )$$

where the ‘visible’ frequencies wk are a subset Ω (of size K) of the set of all frequencies {0, . . . , N−1}. Sensing an object by measuring selected frequency coefficients is the principle underlying Magnetic Resonance Imaging, and is common in many fields of science, including Astrophysics. In the language of the general problem (2.1), the sensing matrix (Φ) is obtained by sampling K rows of the N by N discrete Fourier transform matrix.
We will say that a vector x is S-sparse if its support {i: xi≠0} is of cardinality less or equal to S. Then Candès, Romberg and Tao showed that one could almost always recover the signal x exactly by solving the convex program1 (∥\hat{x}∥ₗ_{₁}=Σᵢ₌₁^{N}|\hat{x}ᵢ|)

$$( {P}_{1} ) {min}_{\tilde{x} ∈ {ℝ}^{N}} {‖ \tilde{x} ‖}_{{l}_{1}} subject to Φ \tilde{x} = y . \qquad ( 2.3 )$$

Theorem 2.1 ([6]). Assume that x is S-sparse and that we are given K Fourier coefficients with frequencies selected uniformly at random. Suppose that the number of observations obeys

K≧C·S·log N. (2.4)
Then minimizing l₁ reconstructs x exactly with overwhelming probability. In details, if the constant C is of the form 22(δ+1) in (2.4), then the probability of success exceeds 1−O(N^{-δ}).
The first conclusion is that one suffers no information loss by measuring just about any set of κ frequency coefficients. The second is that the signal x can be exactly recovered by minimizing a convex functional which does not assume any knowledge about the number of nonzero coordinates of x, their locations, and their amplitudes which we assume are all completely unknown a priori.
While this seems to be a great feat, one could still ask whether this is optimal, or whether one could do with even fewer samples. The answer is that in general, we cannot reconstruct S-sparse signals with fewer samples. There are examples for which the minimum number of samples needed for exact reconstruction by any method, no matter how intractable, must be about S log N. Hence, the theorem is tight and l₁-minimization succeeds nearly as soon as there is any hope to succeed by any algorithm.
The reader is certainly familiar with the Nyquist/Shannon sampling theory and one can reformulate our result to establish simple connections. By reversing the roles of time and frequency in the above example, we can recast Theorem 1 as a new nonlinear sampling theorem. Suppose that a signal x has support Ω in the frequency domain with B=|Ω |. If Ω is a connected set, we can think of κ as the bandwidth of x. If in addition the set Ω is known, then the classical Nyquist/Shannon sampling theorem states that x can be reconstructed perfectly from B equally spaced samples in the time domain². The reconstruction is simply a linear interpolation with a “sinc” kernel.
Now suppose that the set Ω, still of size B, is unknown and not necessarily connected. In this situation, the Nyquist/Shannon theory is unhelpful—we can only assume that the connected frequency support is the entire domain suggesting that all N time-domain samples are needed for exact reconstruction. However, Theorem 2.1 asserts that far fewer samples are necessary. Solving (P₁) will recover x perfectly from about B log N time samples. What is more, these samples do not have to be carefully chosen; almost any sample set of this size will work. Thus we have a nonlinear analog (described as such since the reconstruction procedure (P₁) is nonlinear) to Nyquist/Shannon: we can reconstruct a signal with arbitrary and unknown frequency support of size B from about B log N arbitrarily chosen samples in the time domain. (See Candès, pages 2-4) (internal citations removed).

Furthermore, Candès provides a mathematical overview of sparsity, recovering sparse signals, and the recovery of compressive signals, which is excerpted below.
In all what follows, we will adopt an abstract and general point of view when discussing the recovery of a vector x εR^{N}. In practical instances, the vector x may be the coefficients of a signal f εR^{N} in an orthonormal basis Ψ

$$\begin{matrix}f ( t ) = {\sum }_{i = 1}^{N} {x}_{i} {ψ}_{i} ( t ) , & t = 1 , … , N .\end{matrix} \qquad ( 3.1 )$$

For example, we might choose to expand the signal as a superposition of spikes (the canonical basis of RN), sinusoids, B-splines, wavelets, and so on. As a side note, it is not important to restrict attention to orthogonal expansions as the theory and practice of compressive sampling accommodates other types of expansions. For example, x might be the coefficients of a digital image in a tight-frame of curvelets. To keep on using convenient matrix notations, one can write the decomposition (3.1) as x=Ψf where Ψ is the N by N matrix with the waveforms ψi as rows or equivalently, f=Ψ*x.
We will say that a signal f is sparse in the Ψ-domain if the coefficient sequence is supported on a small set and compressible if the sequence is concentrated near a small set. Suppose we have available undersampled data about f of the same form as before
y=(Φ)f.
Expressed in a different way, we collect partial information about x via y=Φ′x where (Φ)′=(Φ)Ψ*. In this setup, one would recover f by finding—among all coefficient sequences consistent with the data—the decomposition with minimum l₁-norm

min∥\hat{x}∥ₗ_{₁} such that Φ\hat{x}=y
Of course, this is the same problem as (2.3), which justifies our abstract and general treatment. With this in mind, the key concept underlying the theory of compressive sampling is a kind of uncertainty relation [or principle].” (Candès, pages 5-6) (internal citations removed).

Candès further describes a uniform uncertainty principle (UUP) in the following section.
“The UUP essentially states that the K×N sensing matrix (Φ) obeys a ‘restricted isometry hypothesis.’ Let Φ_{T}, T⊂(1, . . . , N) be the K×|T| submatrix obtained by extracting the columns of Φ corresponding to the indices in T; then defines the S-restricted isometry constant δ_{S} of Φ which is the smallest quantity such that

(1−δ_{S})∥c∥ₗ_{₂}²≦∥Φ_{T}c∥ₗ_{₂}²≦(1δ_{S})∥c∥ₗ_{₂}² (3.2)
for all subsets T with |T| thS and coefficient sequences (cⱼ)_{jεT}. This property essentially requires that every set of columns with cardinality less than S approximately behaves like an orthonormal system. An important result is that if the columns of the sensing matrix Φ are approximately orthogonal, then the exact recovery phenomenon occurs.
Theorem 3.1 ([8]). Assume that x is S-sparse and suppose that δ_{2S}+δ_{3S}<1 or, better, δ_{2S}+θ_{S,2S}<1. Then the solution x* to (2.3) is exact, i.e., x*=x.
In short, if the UUP holds at about the level S, the minimum l₁-norm reconstruction is provably exact. The first thing one should notice when comparing this result with the Fourier sampling theorem is that it is deterministic in the sense that it does not involve any probabilities. It is also universal in that all sufficiently sparse vectors are exactly reconstructed from Φ x. In Section 3.4, we shall give concrete examples of sensing matrices obeying the exact reconstruction property for large values of the sparsity level, e.g. for S=O(K/log(N/K)).” (Candès, pages 6-7) (internal citations removed).

Candès further describes how to recover unrecorded data from compressible signals in the following.
A natural question is how well one can recover a signal that is just nearly sparse. For an arbitrary vector x in RN, denote by x_{S} its best S-sparse approximation; that is, x_{S} is the approximation obtained by keeping the S largest entries of x and setting the others to zero. It turns out that if the sensing matrix obeys the uniform uncertainty principle at level S, then the recovery error is not much worse than ∥x−x_{S}∥^{l}^{₁}.
Theorem 3.2 ([9]). Assume that x is S-sparse and suppose that δ_{3S}+δ_{4S}<2. Then the solution x* to (2.3) obeys

$${‖ {x}^{*} - x ‖}_{{l}_{2}} \leq C \cdot \frac{{‖ x - {x}_{S} ‖}_{{l}_{1}}}{\sqrt{S}} . \qquad ( 3.4 )$$

For reasonable values of δ_{4S}, the constant in (3.4) is well behaved; e.g. C≦8.77 for δ_{4S}=⅕. Suppose further that δ_{S}+2θ_{S,S}+θ_{2S},S<1, we also have

∥x*−x∥l₁≦C∥x−x_{S}∥l₁, (3.5)
for some positive constant C. Again, the constant in (3.5) is well behaved.
Roughly speaking, the theorem says that minimizing l₁ recovers the S-largest entries of an N-dimensional unknown vector x from K measurements only. As a side remark, the l₂-stability result (3.4) appears explicitly in [9] while the l₁ instance optimality′ (3.5) is implicit in [7] although it is not stated explicitely. For example, it follows from Lemma 2.1—whose hypothesis holds because of Lemma 2.2. in [8]—in that paper. Indeed, let T be the set where x takes on its S-largest values. Then Lemma 2.1 in [7] gives ∥x*·1_{Tc}∥l₁≦4∥x−x_{S}∥^{l}^{₁} and, therefore, ∥(x*−x)·1_{Tc}∥^{l}^{₁}≦5∥x−x_{S}∥l₁.
We conclude by observing that on T we have

∥(x*−x)·1_{T}∥ₗ_{₁}≦\sqrt{S}∥(x*−x)·1_{T}∥ₗ_{₂}≦C∥x−x_{S}∥ₗ_{₁},
where the last inequality follows from (3.4). For information, a more direct argument yields better constants.
To appreciate the content of Theorem 3.2, suppose that x belongs to a weak-lₚ ball of radius R. This says that if we rearrange the entries of x in decreasing order of magnitude|x|₍₁₎≧|x|₍₂₎≧ . . . ≧|x|_{(N)}, the ith largest entry obeys

|x|₍ᵢ₎≦R·i^{-1/p},1≦1≦N (3.6)
(Candès, pages 7-8)

Those with skill in the art will appreciate that while the quoted sections of Candès above that are provided for illustrative purposes include terms that could be interpreted as potentially absolute or requiring a given thing (e.g., including without limitation “exactly,” “exact,” “only,” “key,” “important,” “requires,” “all,” “each,” “must,” “always,” etc.), the various systems, methods, processing procedures, techniques, and workflows disclosed herein are not to be understood as limited by the use of these terms.

In regard to seismic acquisition, some seismic surveys may acquire signals that are frequency sparse, and which may be modeled as a superposition of a small number of sine and cosine base functions.

In regard to seismic survey designs, compressive sampling may provide the opportunity to perform time-lapse or monitor surveys on a much smaller scale than the original baseline survey. By recovering unrecorded data from sparse or compressed data, survey designs may be implemented using a much smaller scope than previous survey designs. Monitor surveys, for instance, may seek to monitor specific attributes of the subsurface for a region of interest, where monitoring the attributes may include acquiring a smaller amount of data. This smaller amount of data may allow for a reduction in survey dimensions, and therefore the cost of the monitor survey.

FIG. 2 illustrates a flow diagram of a method 200 for designing and performing a monitor survey in accordance with some embodiments disclosed herein. It should be understood that while the operational flow diagram indicates a particular order of execution of the operations, in other implementations, the operations might be executed in a different order. Further, in some implementations, additional operations or blocks may be added to the method 200. Likewise, some operations or blocks may be omitted.

At block 210, a baseline survey dataset (or collected data from an imaging procedure) may be received for a region of interest. The baseline survey dataset may correspond to a survey area, and the region of interest may include the underlying subsurface of the survey area or other multi-dimensional space to be imaged. For example, the region of interest may be a hydrocarbon reservoir. The survey area may define specific survey dimensions for source and receive placement, such as a series of sail lines in a marine seismic survey or a particular source-receiver grid on terrain for a land survey.

In one implementation, a legacy dataset may be used in place of data from a baseline survey. The legacy dataset may include, but is not limited to, data from past seismic surveys. In another implementation, the baseline survey may be oversampled. One reason for oversampling may be to reduce the risk of overlooking any features of interest.

At block 220, the baseline survey dataset may be analyzed for one or more sparsity characteristics using one or more transforms. The analysis may involve transforming the baseline survey dataset into a respective transform's domain, and obtaining a transformed dataset using a transform. The transform may be a linear or a nonlinear transform. Examples of transforms for use in block 220 may include a Fourier transform, a linear Radon transform, a parabolic Radon transform, a wavelet transform, a wave atom transform, a curvelet transform, or any other type of transform. The transformed dataset may be examined to determine the existence, type, quality, or other attributes of sparsity and sparsity-related characteristics.

One example of a sparsity characteristic found in the transformed dataset may be transformed data that occupies a data region relative to a predetermined size in the transformed space. For instance, the sparsity characteristic may exist when the transformed data region is small or less than the predetermined size. A sparsity characteristic algorithm may determine whether the transformed data region is smaller, equal to, or larger than a sparsity threshold. The sparsity threshold may vary between different transforms.

Another example of a sparsity characteristic may include determining that the transformed data has large amplitudes for a predetermined quantity of cells in the transform's domain. For instance, if the baseline survey dataset is transformed onto wavenumbers using a Fourier transform, the transformed dataset may have non-zero contributions for a predetermined number of individual wavenumbers. Using the same transformed dataset, a sparsity characteristic may include an amount of spectral lines below a sparsity threshold. A sparsity threshold may also be a predetermined percentage of spectral lines in the transform domain, and depending on the percentage of spectral lines in the transformed dataset, there may or may not exist a sparsity characteristic. If the Radon transform is used, a sparsity characteristic may include an amount of non-zero values below a sparsity threshold or a predetermined percentage of ray-parameters in the Radon domain. A similar approach may be used for other transforms in order to determine a sparsity characteristic.

At block 225, if sparsity characteristics exist in the transformed dataset, a designated transform may be selected based on a comparison of different transformed datasets produced from the baseline dataset received at block 210. This selection process may include obtaining two or more transformed datasets from the baseline survey dataset using two or more different transforms. For a respective transformed dataset, method 200 may determine one or sparsity characteristics from the respective transformed dataset. Next, the method 200 may compare the sparsity characteristics of the various transformed datasets, such as by ranking the transformed datasets based on their type or quality of sparsity characteristics. The ranking may also be based on each transformed dataset's ability to reduce the dimensions of specific survey parameters in a seismic survey using compressive sampling. For example, selecting the transform may be based on increasing or decreasing specific survey parameters, such as the distance between seismic receivers, seismic source spacing, the number of streamers in a marine seismic survey, any other survey parameters, or a combination thereof. The particular survey parameters to be reduced or increased may depend on the sparsity characteristics made available by the designated transform.

Another method for selecting the designated transform may include using a sparsity measure based on specific attributes of data in a transform domain. For example, where a transform domain is discretized, the transformed data may include a certain number of cells around a cell center, and where the cells may be a certain transform domain distance from the cell center. If the transform domain is the Fourier domain, the transformed data may include cells for a range of discrete wave numbers. If a certain wavenumber does not exist in the transformed data, the corresponding wavenumber cell may be categorized as zero. In this Fourier domain example, a sparsity measure may be the percentage of non-zero cells, which may have to be small or below a sparsity threshold to qualify as a sparse representation.

At block 230, survey parameters for a monitor survey (or surveying parameters for a seismic survey from legacy data or an imaging procedure to collect data related to a multi-dimensional space to be imaged) may be determined or designed based on the sparsity characteristics from block 220. Survey parameters may include the number of streamers for a marine survey, survey area dimensions, receiver spacing, source spacing, source-receiver offsets, distance between common midpoints (CMPs) in the survey, as well as the amount of spatial offset between particular points (e.g., shot points, receiver locations, etc.) of the baseline survey and the monitor survey. Depending on the sparsity characteristics obtained at block 220, the monitor survey may have more leeway for positioning receivers offset from the baseline survey. If the baseline survey data is determined to have weak sparsity characteristics, the monitor survey may need to be positioned precisely or more closely to where the receivers/sources were placed for the baseline survey. In one implementation, determining the survey parameters for a monitor survey may include reducing one or more survey area dimensions of a baseline survey in response to the sparsity characteristics determined at block 220.

At block 240, a monitor survey using the survey parameters from block 230 may be performed to acquire sparse survey dataset. This sparse survey dataset may include fewer sampling locations than the baseline survey. Survey parameters for a monitor survey may be designed with specific monitoring purposes in mind, such as measuring a carbon dioxide leak or any other purpose.

At block 250, unrecorded data is recovered from the sparse survey dataset acquired in block 240 using an estimation operator. The estimation operator may be a recovery algorithm that determines or extrapolates unrecorded data for the monitor survey. The unrecorded data may include locations sampled in the baseline survey, but not the monitor survey. One example of an estimation operator may include using the designated transform obtained in block 220 to transform the acquired sparse survey data into the designated transform's domain. The sparsity characteristics determined in block 220 may then be used to extrapolate unrecorded data in the designated transform's domain. An inverse transform of the designated transform may be applied to the unrecorded data to produce data for the monitor survey in the spatial time domain.

In one implementation, blocks similar to method 200 may be used to design a sparse seismic survey to acquire sparse survey data. Through an analysis of sparsity characteristics in legacy data, survey parameters for the sparse seismic survey may be designed to take into account principles of compressive sampling. The sparse seismic survey data may use an estimation operator to recover unrecorded data similar to the estimation operator used in block 250. The estimation operator may recover data from locations not sampled in the sparse seismic survey or the legacy data. The sparse seismic survey may be a baseline survey for monitor surveys that are also designed to acquire sparse survey data over a similar region of interest as the baseline survey.

In accordance with some implementations, a method for processing collected data is provided. The method may receive a baseline survey dataset for a region of interest. The method may obtain a first transformed dataset from the baseline survey dataset using a first transform. The method may determine sparsity characteristics from the first transformed dataset. The method may determine survey parameters using the sparsity characteristics. The survey parameters may be for a monitor survey for the region of interest.

In some implementations, the method may obtain a second transformed dataset from the baseline survey dataset using a second transform. The method may determine sparsity characteristics from the second transformed dataset. The method may compare the sparsity characteristics from the first transformed dataset with the sparsity characteristics from the second transformed dataset.

In some implementations, the baseline survey dataset may correspond to a survey area, and determining the survey parameters may include reducing the survey area for the monitor survey in response to the sparsity characteristics. The first transform may be a Fourier transform, and sparsity characteristics may be determined based on whether an amount of non-zero wavenumber contributions in the first transformed dataset are below a predetermined sparsity threshold. The survey parameters may include seismic source sampling for the monitor survey, seismic receiver sampling for the monitor survey, source-receiver offsets for the monitor survey, distance between common midpoints (CMPs) in the monitor survey or a combination therein. The survey parameters may include survey area dimensions for the monitor survey. The method may receive a monitor survey dataset that was acquired by performing the monitor survey. The method may recover unrecorded data from the monitor survey dataset using an estimation operator. The estimation operation may be a recovery algorithm based on the sparsity characteristics and an inverse transform of the first transform. The first transform may be a Fourier transform, a linear Radon transform, a parabolic Radon transform, a wavelet transform, a wave atom transform or a curvelet transform.

In some implementations, an information processing apparatus for use in a computing system is provided, and includes means for receiving a baseline survey dataset for a region of interest. The information processing apparatus may also have means for obtaining a transformed dataset from the baseline survey dataset using a transform. The information processing apparatus may also have means for determining sparsity characteristics from the transformed dataset. The information processing apparatus may also have means for determining survey parameters using the sparsity characteristics. The survey parameters may be for a monitor survey for the region of interest.

In some implementations, a computing system is provided that includes at least one processor, at least one memory, and one or more programs stored in the at least one memory, wherein the programs include instructions, which when executed by the at least one processor cause the computing system to receive a baseline survey dataset for a region of interest. The programs may further include instructions to cause the computing system to obtain a transformed dataset from the baseline survey dataset using a transform. The programs may further include instructions to cause the computing system to determine sparsity characteristics from the transformed dataset. The programs may further include instructions to cause the computing system to determine survey parameters using the sparsity characteristics. The survey parameters may be for a monitor survey for the region of interest.

In some implementations, a computer readable storage medium is provided, which has stored therein one or more programs, the one or more programs including instructions, which when executed by a processor, cause the processor to receive a baseline survey dataset. The programs may further include instructions, which cause the processor to obtain a transformed dataset from the baseline survey dataset using a transform. The programs may further include instructions, which cause the processor to determine sparsity characteristics from the transformed dataset. The programs may further include instructions, which cause the processor to determine survey parameters using the sparsity characteristics. The survey parameters may be for a monitor survey for the region of interest.

In accordance with some implementations, a method for processing collected data is provided. The method may receive a legacy survey dataset for a region of interest. The method may obtain a transformed dataset from the legacy survey dataset using a transform. The method may determine sparsity characteristics from the transformed dataset. The method may determine survey parameters using the sparsity characteristics. The survey parameters may be for a seismic survey for the region of interest.

In some implementations, the method may obtain a second transformed dataset from the legacy survey dataset using a second transform. The method may determine sparsity characteristics from the second transformed dataset. The method may compare the sparsity characteristics from the first transformed dataset with the sparsity characteristics from the second transformed dataset.

In some implementations, the legacy survey dataset may correspond to a survey area, and determining the survey parameters may include reducing the survey area for the seismic survey in response to the sparsity characteristics. The first transform may be a Fourier transform, and sparsity characteristics may be determined based on whether an amount of non-zero wavenumber contributions in the first transformed dataset are below a predetermined sparsity threshold. The survey parameters may include seismic source sampling for the seismic survey, seismic receiver sampling for the seismic survey, source-receiver offsets for the seismic survey, distance between common midpoints (CMPs) in the seismic survey or a combination therein. The survey parameters may include survey area dimensions for the seismic survey. The method may receive a sparse survey dataset that was acquired by performing the seismic survey. The method may recover unrecorded data from the sparse survey dataset using an estimation operator. The estimation operation may be a recovery algorithm based on the sparsity characteristics and an inverse transform of the first transform. The first transform may be a Fourier transform, a linear Radon transform, a parabolic Radon transform, a wavelet transform, a wave atom transform or a curvelet transform.

In some implementations, an information processing apparatus for use in a computing system is provided, and includes means for receiving a legacy survey dataset for a region of interest. The information processing apparatus may also have means for obtaining a transformed dataset from the legacy survey dataset using a transform. The information processing apparatus may also have means for determining sparsity characteristics from the transformed dataset. The information processing apparatus may also have means for determining survey parameters using the sparsity characteristics. The survey parameters may be for a seismic survey for the region of interest.

In some implementations, a computing system is provided that includes at least one processor, at least one memory, and one or more programs stored in the at least one memory, wherein the programs include instructions, which when executed by the at least one processor cause the computing system to receive a legacy survey dataset for a region of interest. The programs may further include instructions to cause the computing system to obtain a transformed dataset from the legacy survey dataset using a transform. The programs may further include instructions to cause the computing system to determine sparsity characteristics from the transformed dataset. The programs may further include instructions to cause the computing system to determine survey parameters using the sparsity characteristics. The survey parameters may be for a seismic survey for the region of interest.

In some implementations, a computer readable storage medium is provided, which has stored therein one or more programs, the one or more programs including instructions, which when executed by a processor, cause the processor to receive a legacy survey dataset. The programs may further include instructions, which cause the processor to obtain a transformed dataset from the legacy survey dataset using a transform. The programs may further include instructions, which cause the processor to determine sparsity characteristics from the transformed dataset. The programs may further include instructions, which cause the processor to determine survey parameters using the sparsity characteristics. The survey parameters may be for a seismic survey for the region of interest.

In accordance with some implementations, a method for processing collected data is provided. The method may receive data collected from a first imaging procedure performed on a multi-dimensional region of interest. The method may obtain a transformed data from the received data using a transform. The method may determine sparsity characteristics from the transformed data. The method may determine imaging parameters using the sparsity characteristics. The imaging parameters may describe a second imaging procedure.

In some implementations, an information processing apparatus for use in a computing system is provided, and includes means for receiving data collected from a first imaging procedure performed on a multi-dimensional region of interest. The information processing apparatus may also have means for obtaining transformed data from the received data using a transform. The information processing apparatus may also have means for determining sparsity characteristics from the transformed data. The information processing apparatus may also have means for determining imaging parameters using the sparsity characteristics. The imaging parameters may describe a second imaging procedure.

In some implementations, a computing system is provided that includes at least one processor, at least one memory, and one or more programs stored in the at least one memory, wherein the programs include instructions, which when executed by the at least one processor cause the computing system to receive data collected from a first imaging procedure performed on a multi-dimensional region of interest. The programs may further include instructions to cause the computing system to obtain a transformed data from the received data using a transform. The programs may further include instructions to cause the computing system to determine sparsity characteristics from the transformed data. The programs may further include instructions to cause the computing system to determine imaging parameters using the sparsity characteristics. The imaging parameters may describe a second imaging procedure.

In some implementations, a computer readable storage medium is provided, which has stored therein one or more programs, the one or more programs including instructions, which when executed by a processor, cause the processor to receive data collected from a first imaging procedure performed on a multi-dimensional region of interest. The programs may further include instructions, which cause the processor to obtain transformed data from the received data using a transform. The programs may further include instructions, which cause the processor to determine sparsity characteristics from the transformed data. The programs may further include instructions, which cause the processor to determine imaging parameters using the sparsity characteristics. The imaging parameters may describe a second imaging procedure.

In further implementations, the method may include performing the second imaging procedure, and in some implementations, the method may include comparing the results of the first and second imaging procedures and/or displaying the results of the first and second imaging procedures on a computing system. In some implementations, the method may include iteratively updating a display of results from successive imaging procedures. The method may receive an image dataset that was acquired or collected by performing the second imaging procedure. The method may recover unrecorded data from the image dataset using a recovery algorithm based on an inverse transform of the transform and the sparsity characteristics.

In some implementations, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

In some implementations, the multi-dimensional region of interest includes one or more volume types selected from the group consisting of a subterranean region, human tissue, plant tissue, animal tissue, solid volumes, substantially solid volumes, volumes of liquid, volumes of air, volumes of plasma, and volumes of space near and/or or outside the atmosphere of a planet, asteroid, comet, moon, or other body.

### Computing System

Implementations of various technologies disclosed herein may be operational with numerous general purpose or special purpose computing system environments or configurations. Examples of well known computing systems, environments, and/or configurations that may be suitable for use with the various technologies disclosed herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies disclosed herein may be implemented in the general context of computer-executable instructions, such as program modules, being executed by a computer. Generally, program modules include routines, programs, objects, components, data structures, etc. that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies disclosed herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 3 illustrates a schematic diagram of a computing system 300 in which the various technologies disclosed herein may be incorporated and practiced. Although the computing system 300 may be a conventional desktop or a server computer, as described above, other computer system configurations may be used.

The computing system 300 may include a central processing unit (CPU) 330, a system memory 326, a graphics processing unit (GPU) 331 and a system bus 328 that couples various system components including the system memory 326 to the CPU 330. Although one CPU is illustrated in FIG. 3, it should be understood that in some implementations the computing system 300 may include more than one CPU. The GPU 331 may be a microprocessor specifically designed to manipulate and implement computer graphics. The CPU 330 may offload work to the GPU 331. The GPU 331 may have its own graphics memory, and/or may have access to a portion of the system memory 326. As with the CPU 330, the GPU 331 may include one or more processing units, and each processing unit may include one or more cores. The system bus 328 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 326 may include a read-only memory (ROM) 312 and a random access memory (RAM) 346. A basic input/output system (BIOS) 314, containing the basic routines that help transfer information between elements within the computing system 300, such as during start-up, may be stored in the ROM 312.

The computing system 300 may further include a hard disk drive 350 for reading from and writing to a hard disk, a magnetic disk drive 352 for reading from and writing to a removable magnetic disk 356, and an optical disk drive 354 for reading from and writing to a removable optical disk 358, such as a CD ROM or other optical media. The hard disk drive 350, the magnetic disk drive 352, and the optical disk drive 354 may be connected to the system bus 328 by a hard disk drive interface 336, a magnetic disk drive interface 338, and an optical drive interface 330, respectively. The drives and their associated computer-readable media may provide nonvolatile storage of computer-readable instructions, data structures, program modules and other data for the computing system 300.

Although the computing system 300 is disclosed herein as having a hard disk, a removable magnetic disk 356 and a removable optical disk 358, it should be appreciated by those skilled in the art that the computing system 300 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 300. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 300 may also include a host adapter 333 that connects to a storage device 335 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 350, magnetic disk 356, optical disk 358, ROM 312 or RAM 316, including an operating system 318, one or more application programs 320, program data 324, and a database system 348. The application programs 320 may include various mobile applications (“apps”) and other applications configured to perform various methods and techniques disclosed herein. The operating system 318 may be any suitable operating system that may control the operation of a networked personal or server computer, such as Windows® XP, Mac OS® X, Unix-variants (e.g., Linux® and BSD®), and the like.

A user may enter commands and information into the computing system 300 through input devices such as a keyboard 362 and pointing device 360. Other input devices may include a microphone, joystick, game pad, satellite dish, scanner, or the like. These and other input devices may be connected to the CPU 330 through a serial port interface 342 coupled to system bus 328, but may be connected by other interfaces, such as a parallel port, game port or a universal serial bus (USB). A monitor 334 or other type of display device may also be connected to system bus 328 via an interface, such as a video adapter 332. In addition to the monitor 334, the computing system 300 may further include other peripheral output devices such as speakers and printers.

Further, the computing system 300 may operate in a networked environment using logical connections to one or more remote computers 374. The logical connections may be any connection that is commonplace in offices, enterprise-wide computer networks, intranets, and the Internet, such as local area network (LAN) 376 and a wide area network (WAN) 366. The remote computers 374 may be another a computer, a server computer, a router, a network PC, a peer device or other common network node, and may include many of the elements describes above relative to the computing system 300. The remote computers 374 may also each include application programs 370 similar to that of the computer action function.

When using a LAN networking environment, the computing system 300 may be connected to the local network 376 through a network interface or adapter 333. When used in a WAN networking environment, the computing system 300 may include a router 364 or other means for establishing communication over a wide area network 366, such as the Internet. The modem 364, which may be internal or external, may be connected to the system bus 328 via the serial port interface 332. In a networked environment, program modules depicted relative to the computing system 300, or portions thereof, may be stored in a remote memory storage device 372. It will be appreciated that the network connections shown are merely examples and other means of establishing a communications link between the computers may be used.

The network interface 344 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 374.

It should be understood that the various technologies disclosed herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies disclosed herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, partly on the user's computing device, as a stand-alone software package, partly on the user's computer and partly on a remote computer or entirely on the remote computer or a server computer.

Those with skill in the art will appreciate that any of the listed architectures, features or standards discussed above with respect to the example computing system 300 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method, comprising:
receiving a baseline survey dataset for a region of interest;
obtaining a first transformed dataset from the baseline survey dataset using a first transform;
determining one or more sparsity characteristics from the first transformed dataset; and
determining one or more survey parameters using the one or more sparsity characteristics, wherein the survey parameters are for a monitor survey for the region of interest.

2. The method of claim 1, further comprising:
obtaining a second transformed dataset from the baseline survey dataset using a second transform;
determining one or more sparsity characteristics from the second transformed dataset; and
comparing the sparsity characteristics from the first transformed dataset with the sparsity characteristics from the second transformed dataset.

3. The method of claim 1, wherein the baseline survey dataset corresponds to a survey area, and wherein determining the survey parameters comprises reducing the survey area for the monitor survey in response to the one or more sparsity characteristics.

4. The method of claim 1, wherein the first transform is a Fourier transform, and wherein determining the sparsity characteristics from the first transformed dataset comprises determining whether an amount of non-zero wavenumber contributions in the first transformed dataset are below a predetermined sparsity threshold.

5. The method of claim 1, wherein the survey parameters comprise at least one of the following:
seismic source sampling for the monitor survey;
seismic receiver sampling for the monitor survey;
source-receiver offsets for the monitor survey;
distance between common midpoints (CMPs) in the monitor survey; or
a combination therein.

6. The method of claim 1, wherein the survey parameters comprise survey area dimensions for the monitor survey.

7. The method of claim 1, further comprising receiving a monitor survey dataset that was acquired by performing the monitor survey.

8. The method of claim 7, further comprising recovering unrecorded data from the monitor survey dataset using an estimation operator.

9. The method of claim 8, wherein the estimation operator is a recovery algorithm based on the one or more sparsity characteristics and an inverse transform of the first transform.

10. The method of claim 1, wherein the first transform is selected from a group consisting of:
a Fourier transform;
a linear Radon transform;
a parabolic Radon transform;
a wavelet transform;
a wave atom transform; and
a curvelet transform.

11. A method, comprising:
receiving a legacy survey dataset for a region of interest;
obtaining a first transformed dataset from the legacy survey dataset using a first transform;
determining one or more sparsity characteristics from the first transformed dataset; and
determining one or more survey parameters using the one or more sparsity characteristics, wherein the survey parameters are for a seismic survey for the region of interest.

12. The method of claim 11, further comprising:
obtaining a second transformed dataset from the legacy survey dataset using a second transform;
determining one or more sparsity characteristics from the second transformed dataset; and
comparing the sparsity characteristics from the first transformed dataset with the sparsity characteristics from the second transformed dataset.

13. The method of claim 11, wherein the legacy survey dataset corresponds to a survey area, and wherein determining the survey parameters comprises reducing the survey area for the seismic survey in response to the one or more sparsity characteristics.

14. The method of claim 11, wherein the first transform is a Fourier transform, and wherein determining the sparsity characteristics from the first transformed dataset comprises determining whether an amount of non-zero wavenumber contributions in the first transformed dataset are below a predetermined sparsity threshold.

15. The method of claim 11, wherein the first transform is selected from a group consisting of:
a Fourier transform;
a linear Radon transform;
a parabolic Radon transform;
a wavelet transform;
a wave atom transform; and
a curvelet transform.

16. The method of claim 11, wherein the survey parameters comprise survey area dimensions for the seismic survey.

17. The method of claim 11, further comprising:
receiving a sparse survey dataset that was acquired by performing the seismic survey; and
recovering unrecorded data from the sparse survey dataset using a recovery algorithm based on an inverse transform of the first transform and the one or more sparsity characteristics.

18. A method, comprising:
receiving data collected from a first imaging procedure performed on a multi-dimensional region of interest;
obtaining transformed data from the received data using a transform;
determining one or more sparsity characteristics from the transformed data; and
determining one or more imaging parameters using the one or more sparsity characteristics, wherein the imaging parameters describe a second imaging procedure.

19. The method of claim 18, further comprising receiving an image dataset that was acquired by performing the second imaging procedure.

20. The method of claim 19, further comprising recovering unrecorded data from the image dataset using a recovery algorithm based on an inverse transform of the transform and the one or more sparsity characteristics.
